(19) United States
(12) Patent Application Publication
(10) Pub. No.: US 2003/0217570 A1
(43) Pub. Date: Nov. 27, 2003

(54) Personal hygiene device

(76) Inventor: Rafael J. Dacosta, Miami, FL (US)

Correspondence Address: David P. Lhota, Stearns Weaver Miller, et al., Suite 1900, 200 East Broward Boulevard, Fort Lauderdale, FL, 33301, US

(21) Appl. No.: 10/375,861

(22) Filed: Feb. 27, 2003

Related U.S. Application Data
(60) Provisional application No. 60/360,471, filed on Feb. 27, 2002.

(51) Int. Cl. B08B 3/00

(52) U.S. Cl. 68/200; 134/184

(57) ABSTRACT

A personal washing system having a water purification chamber, cleaning agent injection system, mixing chamber for mixing a cleaning agent with water to produce a cleaning solution, and application hose and nozzle for applying the cleaning solution to an area being cleaned.

### CROSS REFERENCE TO RELATED APPLICATIONS

This application claims the benefit of provisional application Serial No. 60/360,471 filed Feb. 27, 2002.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to a washing device and system, and more particularly, to a personal body and clothing washing system that selectively mixes and dispenses water, soap, detergent, fragrance and, or disinfectants.

2. Description of the Background Art

Washing systems, such as bidets, are well known in the art, and common in Europe and expensive homes. Public restrooms and average homes, however, do not have bidets. In many instances, this is because of size and, or budget constraints. Because of the cleaning advantages afforded by bidet systems and the practical limitations preventing wide spread use of bidets, there exist a need for a personal washing device that is more widely available, easily adaptable for use in existing bathrooms and with existing toilets and faucets, transportable and affordable. The instant invention addresses this need.

### BRIEF SUMMARY OF THE INVENTION

Based on the foregoing, it is a primary object of the present invention to provide a personal washing device that is adaptable for use in existing bathrooms for personal hygiene.

It is an object of the instant invention to provide a personal washing device that may be used for washing clothes.

It is another object of the instant invention to provide a personal washing device that is removably installable and, or portable and readily attachable to existing sources of water.

It is also an object of the present invention to provide a personal washing device that is readily available and ergonomically adapted for washing personal body areas.

It is another object of the present invention to provide a personal washing device that is relatively less expensive to manufacture and install compared to conventional washing systems, such as bidets.

It is a further object of the present invention to provide a personal washing device that provides proper and hygienic cleansing whenever and wherever needed.

It is yet another object of the present invention to provide a personal washing device that offers a convenient and easy system for the physically challenged.

It is yet an additional object of the present invention to provide a personal washing device that provides proper and hygienic cleansing whenever and wherever needed.

It is yet a further object of the present invention to provide a personal washing device that is easily installed and removed.

It is still another object of the present invention to provide a personal washing device that can be used for storing and replacing various washing agents.

It is still an additional object of the present invention to provide a personal washing device that can be used for storing and applying cleaning agents for washing and, or removing stains from fabrics.

In light of these and other objects, the instant invention provides a personal washing device that is primarily for cleaning personal body areas, self-contained in protective enclosure and adapted for use with existing commodes and, or faucets as an installed or portable unit. The personal washing device comprises a purifying chamber, mixing chamber, structure for receiving water and washing additives, such as soap, detergent or other conventional cleaning agents, injection system, applicator and enclosure for securing, holding and protecting the system components. The noted components of the instant invention mechanically cooperate and fluidly communicate to dispense a washing solution made by the instant invention.

The personal washing device has an inlet and at least one hose or other type of conduit having a connector, for tapping into and receiving a source of water. Water is received through the inlet and passes through the purifying chamber, injection system, mixing chamber, application hose and intervening conduit, tubing or hoses. The injection system may comprise an air pump or charged gas system, which provides the force for forcing the water and cleaning solution through the system. The purifying chamber has a filter and removes impurities and targeted minerals from the water. The water then passes into the mixing chamber, which is fluidly connected to a cleaning agent source. The water and cleaning agent are mixed together in the mixing chamber to make a cleaning solution. The cleaning agents are preferably fluidly connection to the injection system, but may be connected directly to the mixing chamber. The cleaning solution is dispensed, such as by spraying, through the application hose and nozzle. The nozzle has an ergonomically designed, replaceable head for directing the mixing solution as it exits the system. The nozzle preferably has a control valve connected between the head and nozzle for closing and, or adjusting pressure. The personal washing system may include spare heads and various head styles for varying the spray configurations. The instant invention may also include spare gas cartridges and cleaning agent refills and accessories such as pre-moistened disinfectant towels, pre-moistened detergent towels and packaged single-use concentrate.

The personal hygiene device is conveniently stored and secured in a protective enclosure. The enclosure preferably defines two compartments that are attached together along a common edge by hinges and locked together by a latch. One compartment contains the purifying chamber, mixing chamber and injection system fluidly connected together, application hose with the nozzle and any accessories, hoses or tubing that might be needed, such as tubing for connecting to a water source. The system preferably employs quick connecting valves, adapters and tubing for convenient set-up. The other compartment preferably stores other accessories, such as the disinfectant towels, detergent towels, spare gas cartridges and spare nozzle heads. The inside of the enclosure may be lined with foam and, or insulation for protecting the contents from impact. The enclosure may be adapted for temporary or semi-permanent installation in a bathroom or washroom. The enclosure may also be designed as a portable unit for use at work or while traveling.

In accordance with the summary of the invention, listed objects and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is an elevational view of the personal hygiene device in accordance with the preferred embodiment of the instant invention showing the mixing and pumping system.

FIG. 2 is an elevational view of the personal hygiene device in accordance with another preferred embodiment of the instant invention showing the mixing and pumping system.

FIG. 3 is an elevational view of the personal hygiene device in accordance with the preferred embodiment of the instant invention illustrating a complete system.

FIG. 4 is an elevational view of the personal hygiene device' accessory compartment in accordance with the preferred embodiment of the instant invention

### DETAILED DESCRIPTION OF THE INVENTION

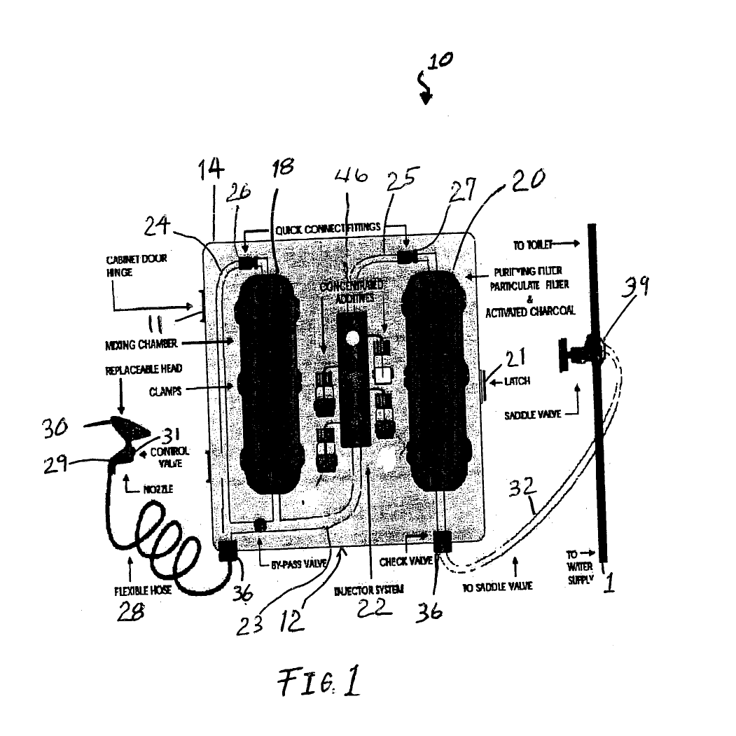

With reference to the drawings, FIGS. 1-4 depict the preferred and alternative embodiments of the instant invention which is generally referenced as a personal hygiene device and, or by numeric character 10. The personal hygiene device 10 comprises a self contained, personal transportable washing bidet system for attachment to and use with standard toilets and, or faucets. The device 10 allows the user to perform personal cleansing wherever and whenever they desire. The device 10 can also be used to wash stains from clothing. The invention 10 allows the user to “freshen up” whenever they desire as well as have washing solution available for personal uses.

Referring to the drawings, the personal hygiene device 10 comprises an enclosure 12, mixing chamber 18, purifying chamber 20, injection system 22, application hose 28 with a replaceable nozzle 29. The system 10 may also include additional tubing, such as a water source tapping hose 32 and quick-connect adapters and valves, such as 26, 27 and 35, water source hose with adapter 32 and, or gas cartridges 38 for a gas charged injection system. The system 10 may also comprise cleaning agents and spare parts, and preferably pre-moistened disinfectant towels 42, pre-moistened detergent towels 44, packaged single-use cleaning agent concentrate cartridges 46, spare gas cartridges 38 and spare nozzle heads 30.

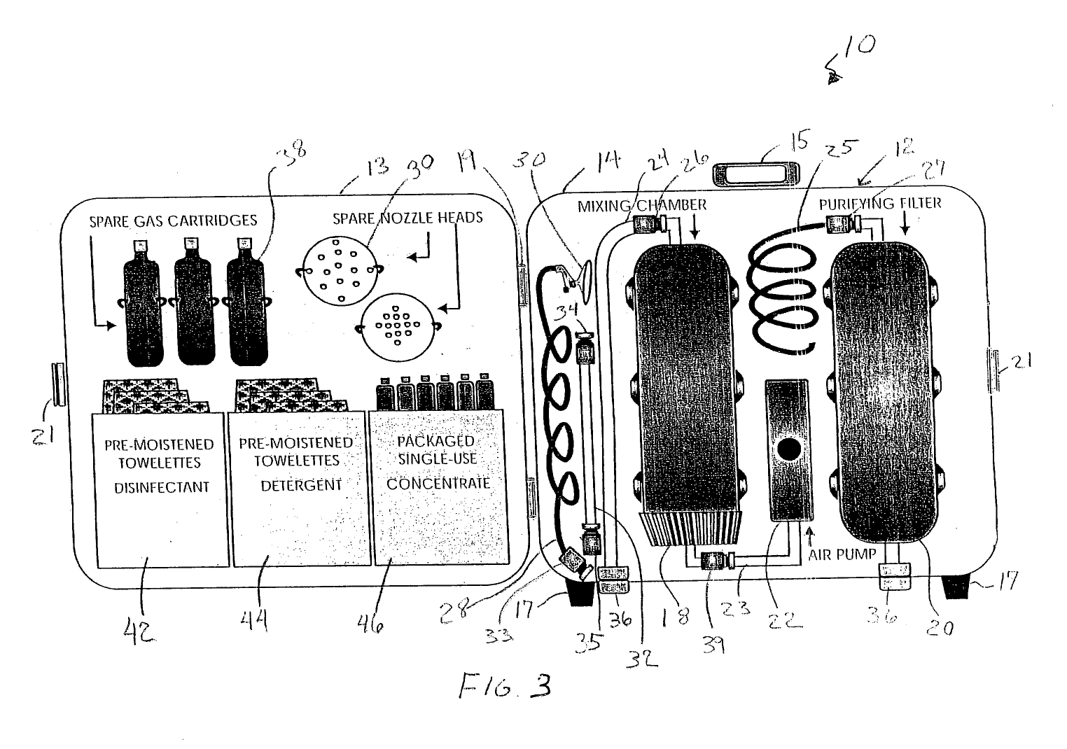

With reference to FIG. 3, the enclosure 12 comprises a first compartment 14 and second compartment 13, which are connected along a common edge by at least one hinge 13 and can be securely closed by a latch or lock 21. The first compartment 14 preferably contains the purifying chamber 20, mixing chamber 18 and injection system 22, which are fluidly connected together in the compartment 14, application hose 28 with the nozzle 30 and any accessories, hoses or tubing that might be needed, such as tubing 32 for connecting to an adapter 39 to a water source 1. The second compartment 13 preferably stores other accessories, such as the pre-moistened disinfectant towels 42, detergent towels 44, packaged cleaning agents 46, spare gas cartridges 38 and, or spare nozzle heads 30. The enclosure 12 is preferably made from a hardened, durable plastic or plastic-based material. The inside of the enclosure 12 may be lined with foam and, or insulation for protecting the contents from impact. The enclosure may be adapted for temporary or semi-permanent installation in a bathroom or washroom. The enclosure may also be designed as a portable unit for use at work or while traveling.

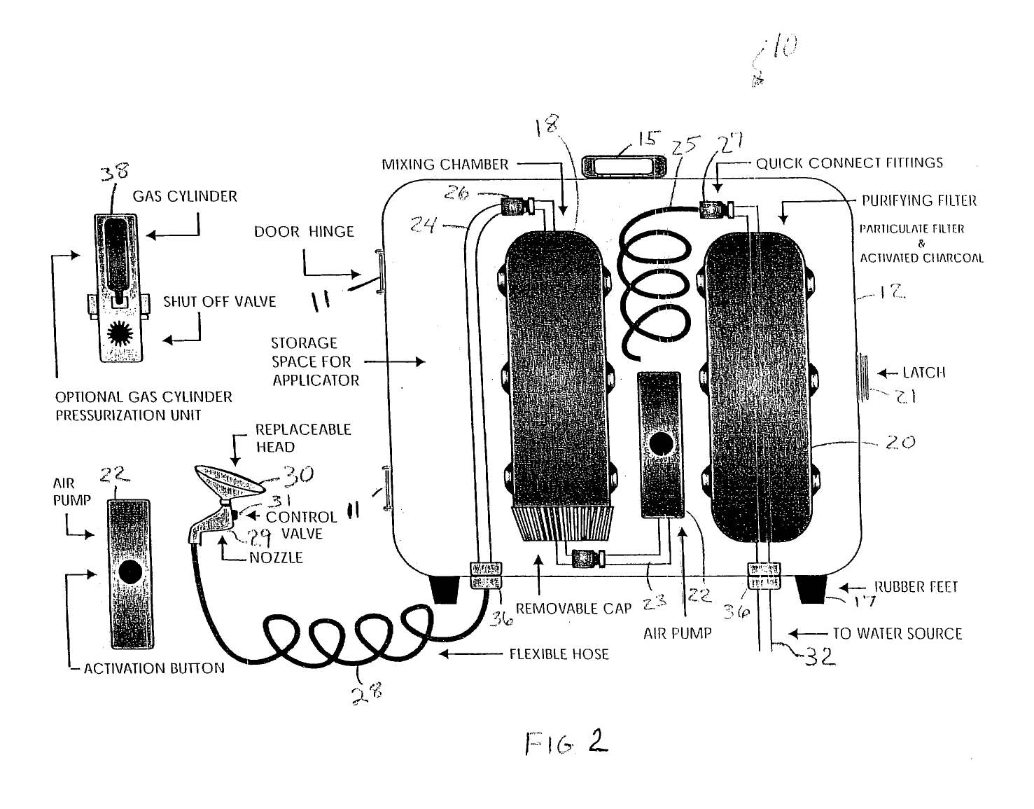

With reference to FIGS. 1 and 2, the purifying chamber 20 is fluidly connected at one end to a water source 1, such as with a water source tube 32 having quick connects 36, and to the injector system 22 at the other end by a tube or conduit 25. The injection system 22 may comprise an air pump or gas charged pump. The cleaning agent packages 46 may be connected directly to the injection system for drawing cleaning agents and controlling the amount of cleaning agent be mixed in the mixing chamber 18. The mixing chamber 18 is fluidly connected to the injection system's 22 outlet at one end and a cleaning solution dispensing tube 24 at the other end. The nozzle 29 is connected to the exit end of the application hose 28 and includes a control valve 31 for controlling the pressure of the spray and a nozzle head 30 for directing flow. The application hose 28 releasably connects to the tube 24 with quick-connect 36.

Still referring to FIGS. 1 and 2, the purifying chamber 20 fluidly communicates with the mixing chamber 18 and comprises a filter for cleaning the water. The mixing chamber 18 combines the purified water and cleaning agent in proper concentration for delivery through the tubing 24 and the application hose 28 and nozzle 29 assembly. The mixed solution is dispensed from and directed by the nozzle head 30. The injection system 22 and air pump connection tubing 23 facilitate the mixing and dispensing of the water and solution. The injection system 22 is activated and deactivated by engaging an activation button. The control valve 31 comprises a push button valve and resides in the nozzle 29 and controls the flow of solution out the nozzle head 30. The gas cylinder 38 charges the mixing chamber 18 and is connected to a shut off valve for controlling the charging process, as shown in FIG. 2.

The convenience of the instant invention is enhanced by the use of quick-connect adapters, such as saddle valves. The water source hose 32 preferably includes saddle valve adapters 34 and 35 at its ends for providing a quick-connection to a water source. The personal hygiene device 10 preferably uses saddle valves or quick-connect adapters for all tubing connections including connectors 27, 26, 39, 34, 35, and 36. The personal hygiene device 10 may be fitted with other quick connect and disconnect couplings to allow the device to be used with pre-existing water valves instead of having to use and abandon a saddle valve.

Input water is initially forced through the purifying chamber 20 and into the mixing chamber 18 where soap, detergent, fragrance or disinfectant are added as needed. The mixed solution is transferred via the length of tubing 24 and hose 28 to a hand held nozzle 29 for application of the cleansing solution to the desired area. The mixing chamber 18 may be bypassed for using purified water from the purifying chamber 20 to rinse the desired area.

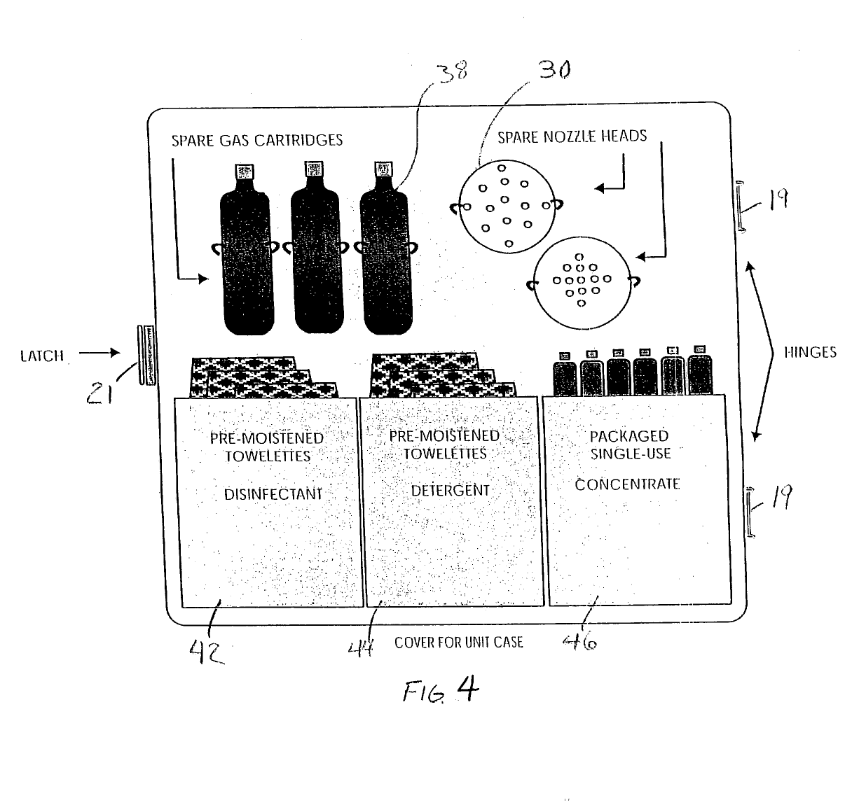

The mixing chamber 18 is connected in line with the purifying chamber 20. The invention 10 has provisions for the connection of one or more replaceable canisters of concentrated soap, detergent, fragrance or disinfectant to an injection manifold, as shown in FIGS. 2 and 4. An injection manifold is connected to the mixing chamber 18 to allow the introduction of concentrated additives. The coiled length of tubing 28 connects the mixing chamber 18 to the hand held nozzle 29. The hand held nozzle 29 has a push button regulating or control valve 31 to monitor the amount of cleansing solution to be applied. The hand held nozzle 29 has detachable, replaceable heads 30 for producing various spray patterns. The invention 10 has a provision to direct the purified water from the purifying chamber 20 directly into the dispensing nozzle 29 bypassing the mixing chamber 18. The purifying chamber 20 is connected with quick disconnect fittings that do not require tools for disassembly. The concentrated additive canisters 46 are connected with quick disconnect fittings that do not require tools for disassembly. The invention is contained in a small plastic case 12 fitted with a hinged door for easy access to the internal components.

The entire invention is contained in a small case 12. The first compartment 13 and second compartment 14 are connected by hinges 19 for opening and closing the case. The case 12 also includes a handle 15 for transporting the personal hygiene device 10. The case 12 comprises a molded acrylonitrile-butadiene-styrene (ABS) co-polymer or polyvinyl chloride (PVC) plastic cabinet with a hinged door. The replaceable gas cartridges 38 are made from PVC plastic and are equipped with easily connected and disconnected fittings. The disposable purifying chamber 20 contains a particulate filter and an activated charcoal filter to remove odors and microorganisms from the input water. The mixing chamber 18 is made from PVC plastic for long life and resistance to chemical action from concentrated materials used with the system.

Soap, detergent, fragrance or disinfectant is stored in small stainless steel or PVC plastic canisters and a measured amount is introduced into the mixing chamber via small push button stainless steel or PVC plastic injection valves. The mixed solution is transferred from the mixing chamber via a length of flexible PVC tubing to a hand held PVC plastic nozzle fitted with a metering valve.

The instant invention is used as follows. The personal hygiene device 10 is connected to a source of pressurized water using the saddle valve or quick connect fittings 36 and 34 or 35. The input water is turned on to provide flow. The desired amount of concentrated additive is injected into the mixing chamber 18 using the push button valves. The push button valve 31 on the dispensing nozzle 29 is temporarily opened to allow flow of input water into the mixing chamber 18. The mixed solution is dispensed in the quantity needed using the desired nozzle head 30. The by-pass valve is actuated when purified water only is desired. After use the input valve is turned off, the dispensing control valve 31 actuated to remove excess pressure and the dispensing assembly stored in the cabinet for future use. Replacement canisters 46 of concentrated additive are exchanged as necessary.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A personal washing system comprising:
a means for receiving water from a water source;
a purifying chamber;
a mixing chamber in fluid communication with said purifying chamber;
means for introducing at least one cleaning agent into said mixing chamber, said mixing chamber mixing the water and cleaning agent to produce a cleaning solution at a predetermined concentration;
means for dispensing said solution from the system; and
means for pumping the received water into the mixing chamber and to the dispensing means.

2. A system as recited in claim 1, further comprising a spray nozzle connected to said dispensing means.

3. A system as recited in claim 1, further comprising an enclosure for storing said system.
